(19) United States
(12) Patent Application Publication
(10) Pub. No.: US 2024/0417921 A1
(43) Pub. Date: Dec. 19, 2024

(54) IMITATION LEATHER

(71) Applicant: TomTex, Inc., Brooklyn, NY (US)

(72) Inventors: Uyen Thi Thao Tran, New York, NY (US); Andrew Ross MacKay McBee, New York, NY (US); Anil Narayan Netravali, Littleton, MA (US)

(21) Appl. No.: 18/817,738

(22) Filed: Aug. 28, 2024

Related U.S. Application Data
(63) Continuation of application No. PCT/US2023/013636, filed on Feb. 22, 2023.
(60) Provisional application No. 63/314,711, filed on Feb. 28, 2022.

(51) Int. Cl. D06N 3/00; D06N 3/12; D06N 3/16; D06N 3/18

(52) U.S. Cl. CPC D06N 3/0015; D06N 3/0006; D06N 3/0011; D06N 3/0059; D06N 3/0095; D06N 3/12; D06N 3/16; D06N 3/18; D06N 2203/024; D06N 2205/20; D06N 2205/243; D06N 2209/103; D06N 2211/28

(57) ABSTRACT

A leather-like material is disclosed composed of chitosan, bulk reinforcement agents such as microfibrillated cellulose, pigments, plasticizers, crosslinkers, and organic acids with properties making it suitable as a leather substitute material.

### CROSS REFERENCE

This application is a continuation of International Patent Application No. PCT/US2023/013636, filed Feb. 22, 2023, which claims priority from U.S. 63/314,711, filed Feb. 28, 1922, each of which are incorporated herein by reference.

### FIELD OF THE INVENTION

The present disclosure relates generally to imitation leathers and manufacturing thereof.

### BACKGROUND

Conventional leathers drive negative climate impacts like deforestation and large carbon footprints and often are fabricated using highly toxic and polluting tanning processes that contaminate the water table and affect workers' health. Also, most leather comes from thousands of animals that are killed each year. It would be valuable to develop sustainable alternatives to these materials and processes to protect both people and the planet. While there exist a class of faux leathers marketed as sustainable options, they are often simply plastic products derived from petrochemicals (e.g., PVC or vinyl), with concomitant negative environmental impacts like polluting feedstock generation processes, hundreds- or thousand-year biodegradation timelines, and microplastic generation, as well as poor hand-feel compared to conventional leathers. Most materials/products also end up in landfills. Besides, petroleum itself is not a sustainable raw material. There is, therefore, a great need to develop a truly sustainable alternative to both conventional leathers and plastic-based leathers sourced from sustainable feedstocks.

Previous work at Tufts University (L. Mogas-Soldevila, et al; Additively manufactured leather-like silk protein materials, Materials & Design, Vol 203, 2021, 109631) has described a primarily protein-based material with chitin reinforcement that can be used to replicate leathers by a 3D printing process. The materials described derive their performance from the 3D printing process, both in terms of obtaining the desired nanostructure by, e.g., biomimetic shear alignment of silk fibroin protein and macrostructure, in the actual 3D printed pattern. This approach allows for a sustainable, protein-based material, but may scale poorly due to the limitations of 3D printing (e.g., slow production rate) and uses a primarily protein-based input material in silk fibroin that must compete with conventional uses of silk peptides.

Previous work at Harvard University (Fernandez, J. G. and Ingber, D. E. (2012), Unexpected Strength and Toughness in Chitosan-Fibroin Laminates Inspired by Insect Cuticle. Adv. Mater., 24: 480-484) describes bio-inspired laminar films of protein and chitosan which exhibit surprising increases in strength compared to pure protein-chitosan blends. This property arises emergently from the interaction of the phase-separated layers, and can be enhanced with micromolding and other patterning techniques. The material absorbs water readily, which was utilized to tune its mechanical behavior. However, undesired water absorption, e.g., in humid environments, during use would deteriorate their mechanical properties, affect their characteristics and performance and render them unusable.

A number of patents have described similar protein-chitosan hybrid or composite leather substitute materials, (e.g., CN107057448, CN107801719, and JPH03152130) along with other resinous, plastic, and/or mineral components. Similarly, patent CN106977955 covers a coating to be applied to an existing leather product to improve its pile-feel. None of this prior art describes a pure chitosan or chitosan-cellulose fibril hybrid composition for use as a leather substitute material, and typically include a protein fraction as a major component of their recipes.

Previous work at Harvard University (Fernandez, J. G. and Ingber, D. E. (2014), Manufacturing of Large-Scale Functional Objects Using Biodegradable Chitosan Bioplastic. Macromol. Mater. Eng., 299: 932-938) has described the use of chitosan-based recyclable materials in the form of chitosan solubilized by acetic acid and then cast or injection molded into final shapes. These materials may exhibit high shrinkage and, due to their high crystallinity, may be hard rather than flexible when cast as thick films, making them more suitable for injection molding or objects requiring high stiffness. The material is also not water resistant, and may be dissolved back into a liquid form as part of the recycling process.

These examples of previous work highlight the opportunity for a chitosan-based, solution cast material with fibrillar cellulose reinforcement and post-treatment for water resistance as a viable, economic, and eco-friendly leather alternative.

### SUMMARY

One aspect of the invention is a leather-like material composed of chitosan, bulk reinforcement agents such as nano- and microfibrillated cellulose (“MFC”, also known as cellulose nanofibrils), pigments, plasticizers, crosslinkers, and an organic acid for use as a leather substitute material.

Another aspect of the invention is a process for generating the above leather-like material consisting of particular mixing, solubilizing, molding (into desired shapes) or coating onto webs or release substrates, and drying and optional embossing steps to form a suitably patterned thick sheet material.

Another aspect of the invention is a process which comprises a post-treatment step in order to add water-resistance to the material, if the initial process does not itself inherently provide water resistance: i.e., a post-molding treatment which comprises neutralization, coating, crosslinking, and/or an amine-capping chemical reaction to render the material water resistant while preserving its aesthetic and mechanical performance.

### BRIEF DESCRIPTION OF THE DRAWINGS

FIG. 1 illustrates the production of chitosan from chitin.

FIG. 2 illustrates chitosan anime group modification.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

One embodiment of the invention is a leather-like material comprising: 1) 10-90 wt/wt % chisosan, preferably 15-85 wt/wt %, most preferably 20-80 wt/wt %, wherein the chitosan is of 10-530 KDa MW, more preferably of 25-300 KDa MW, most preferably of low MW 50-200 KDa having a DD of 50-99%, more preferably 75-99%, most preferably >80%; 2) 0.01-50 wt/wt % microfibrillated cellulose/cellulose nanofiber (MFC/CNF), more preferably 5-30 wt/wt %, most preferably 10-20 wt/wt %; 3) 10-60 wt/wt % organic acid such as lactic acid, citric acid, or formic acid or other organic acids or a combination thereof, more preferably 15-50 wt/wt %, most preferably 25-50 wt/wt %; 4) 0.01-25 wt/wt % organic plasticizer such as sorbitol, polyethylene glycol, sorbitol, or other polyols, more preferably 5-20 wt/wt %, most preferably 10-15 wt/wt %; and 5) residual water content of 0-30 wt/wt %, more preferably 0-15 wt/wt % and most preferably 0-10 wt/wt %. Optionally, the material of the invention contains no plasticizer and/or no MFC/CNF.

One embodiment of the invention is a leather-like material comprising: 1) 10-70 wt/wt % chisosan, preferably 15-50 wt/wt %, most preferably 20-30 wt/wt %, wherein the chitosan is of 10-530 KDa MW, more preferably of 25-300 KDa MW, most preferably of low MW 50-200 KDa having a DD of 50-99%, more preferably 75-99%, most preferably >80%; 2) 0.01-50 wt/wt % microfibrillated cellulose/cellulose nanofiber (MFC/CNF), more preferably 5-30 wt/wt %, most preferably 10-20 wt/wt %; 3) 10-60 wt/wt % organic acid such as lactic acid, citric acid, or formic acid or other organic acids or a combination thereof, more preferably 15-50 wt/wt %, most preferably 25-50 wt/wt %; 4) 0.01-25 wt/wt % organic plasticizer such as sorbitol, polyethylene glycol, sorbitol, or other polyols, more preferably 5-20 wt/wt %, most preferably 10-15 wt/wt %; and 5) residual water content of 0-30 wt/wt %, more preferably 0-15 wt/wt % and most preferably 0-10 wt/wt %. Optionally, the material of the invention contains no plasticizer and/or no MFC/CNF.

In another embodiment of the invention the material further comprises one or more of the components above, with the addition of short cellulosic fibers (cotton, viscose, lyocell, and others) or pulp (e.g., kraft pulp) of most preferably >0-50 wt/wt %, more preferably 10-40 wt/wt % and most preferably 20-30 wt/wt % to change the final material handfeel and surface texture.

In another embodiment of the invention, the material further comprises one or more of the components above, with the addition of short chopped cellulosic fibers (e.g., “flock”) most preferably >0-20 wt/wt %, more preferably >0-10 wt/wt %, and most preferably 0.1-5 wt/wt %, which are applied to the surface of the material using a flocking system, most preferably an electroflocking system. Such fibers may be adhered to the material using one or more of the components above in liquid form as an adhesive. Other natural adhesives, e.g. dopamine or latex based, may also be used.

In another embodiment of the invention, the material further comprises one or more of the components above, with the addition of a woven or non-woven backing fabric, applied to the material using one or more of the components above in liquid form as an adhesive, or an alternative adhesive, such as a natural rubber latex, epoxidized natural rubber, natural mastic glue, or dopamine-based glues, in order to increase material tear strength.

In another embodiment of the invention the material further comprises one or more of the components above, with the addition of salts formed from the acid present in the material neutralized with a suitable base such as sodium hydroxide, potassium hydroxide, ammonium hydroxide, or ammonia, i.e. sodium lactate or potassium formate with a residual concentration of 0-20% v/w %, more preferably, 0-15% v/w % and most preferably 0.1-10 v/w %.

In another embodiment of the invention the material further comprises one or more of the components above, with the addition of a crosslinking agent like glutaraldehyde, glyoxal, sugar aldehyde (such as glucose polyaldehyde, acetylglucosamine polyaldehyde, cellulose polyaldehyde, sucrose ditetraaldehyde, or sucrose tetraaldehyde), or genipin with a concentration 1-40% v/w %, more preferably, 5-30% v/w %, and most preferably 10-20 v/w %.

In another embodiment of the invention the material further comprises one or more of the components above, with the addition of a Michael-active or Aldol-active compound like alpha-beta unsaturated carbonyl compounds, aldehydes, or ketones like cinnamaldehyde at a concentration of 1-20% v/w, more preferably, 5-10% v/w.

In another embodiment of the invention the material further comprises one or more of the components above, including citric acid, lactic acid, or formic acid with the addition of a protein or peptide (such as silk peptide) at a concentration of 1-50% v/w, more preferably 10-40% v/w, and most preferably 20-30 v/w, which will be crosslinked by the acid to improve water resistance.

In another embodiment of the invention, the solids content of the recipes above is decreased by use of reduced solubilizing water volumes, producing higher viscosity dopes more suitable for continuous processing by roll-to-roll techniques. Final solids contents may be increased to 4-20 wt %, more preferably 5-18 wt %, or most preferably 6-15 wt %. At higher solids contents, viscosities may be become unusably high, or gelling may occur, limiting pumping and pouring operations.

One embodiment of the invention is a process for producing the leather-like material of the invention which comprises mixing, solubilizing, molding, and drying steps to form a suitably patterned thick sheet material. In one embodiment of the process, the above chitosan and MFC/CNF are mixed to homogeneity in water under high shear in order to fully disperse aggregate MFC/CNF fibers and fibrils using a dispersion mixer e.g. a high-speed toothed mixing blade (typically >2000 feet-per-minute (fpm) tip speed) or a high-speed blade in combination with low-rpm paddle agitator (typically 1000-2000 fpm) along with coloring agents like dyes or pigments in a final water mass of liquid of 10×-50×, more preferably 15×-35×, and most preferably 25×-30× the mass of the chitosan. Typical mixers are Ninja, KitchenAid, Nutribullet, Vitamix, and Phillip High Speed. However, any other high-speed mixers will do. After homogenization, the remaining ingredients are added and mixed to homogeneity under lower shear. During mixing, the solution can be gently heated to 25-90° C., more preferably 30-60° C., most preferably 40-50° C. to assist dissolution. The mixture is then cast into a mold with or without a pattern and the water evaporated under gentle heating of 25-90° C., more preferably 30-70° C., most preferably 50-60° C., with gentle airflow over the mold surface of 0-5 m/s more preferably 1-4 m/s and most preferably 2-3 m/s. The inventive material can be dried under still conditions by simple air diffusion, which is the most gentle method.

Another embodiment of the invention comprises a coating method whereby one or more of the above components is formed into a sheet in a continuous process with the aid of a web coating operation and tunnel dryer. Coating methods applicable may include knife coating, comma coating, slot-die coating, or any other methods suitable for applying thick (>500 μm) wet layers to substrates. Suitable substrates may include natural woven or non-woven fabrics to produced backed films or patterned or plain release papers to produce free standing plain or textured films. Multi-layer films may be formed using multiple coating operations, or laminates may be formed by layering re-wetted non-waterproofed films with or without the addition of additional dope.

Another embodiment of the invention comprises one or more of the above components, with the addition of some concentration of monosaccharide or reducing disaccharides such as glucose or maltose at 0-20%, wt/wt %, more preferably 0.005-10%, and most preferably 0.01-5%. As the material dries, reducing sugars undergo Maillard and other browning-type reactions, producing amine-reactive molecules such as glyoxal or other mono- and di-aldehydes, which may act as in-situ produced crosslinkers or polymer chain modifiers.

In another embodiment, one or more of the above components, with the addition of sodium dodecyl sulfate (SDS) at 0-5%, more preferably 0.025-2%, and most preferably 0.05-1% as a foaming agent are mixed all at high rates to force air into the mixture. After mixing, the liquid material is cast as above at a high heating rate to trap SDS/MFC-stabilized air bubbles in the material and control final material density. Alternately, vacuum degassing may be used to remove the air bubbles.

Another embodiment of the invention is a post-treatment step to add water resistance to the leather-like material of the invention which comprises neutralization of free and chitosan-salted acid to render the material no longer water soluble. In this embodiment, the dried film as obtained above is removed from the mold and immersed in a base bath in water or other polar solvent such as glycerol, other liquid glycols, or suitably polar alcohols such as methanol, ethanol, or isopropanol at a concentration of 0.1-19.4M, more preferably 0.1-15M, more preferably 0.1-10M and most preferably 0.5M-5M, of sufficient relative molar concentrations to nearly or fully neutralize the chitosan acid salt, at a temperature of 15-90° C., more preferably 20-60° C., and most preferably 20-30° C. The material is kept immersed in the bath for a time such as 0.01-48 hr, more preferably 1-24 hr, most preferably 1-12 hr. After neutralization, the material is placed in one or more secondary baths and washed to remove the resulting salts as well as residual unsalted/unreacted base. Alternatively, the material may be placed in one or more secondary baths, and the remaining residual base neutralized to pH of 6-8 by addition of another acid such as hydrochloric, lactic, acetic, or formic acid, which may or may not be followed by additional baths to remove the resulting salts.

Another embodiment of the invention is a post-treatment step to add water resistance to the leather-like material of the invention which comprises coating, crosslinking, and/or amine-capping chemical reaction. In this embodiment, the dried film as obtained above is removed from the mold and immersed in a bath of molten long-chain fatty acid such as stearic acid (or others such as capric acid, lauric acid, palmitic acid, oleic acid, linoleic acid, and others) at a temperature of 70-120° C., more preferably 70-100° C., and most preferably 80-90° C. The material is held immersed in the bath for a time, 0.5-5 hr more preferably 1-3 hr, most preferably 1-2 hr.

In another embodiment, the above protocol is followed with the substitution of lauric acid for stearic acid.

In another embodiment, after the material is removed from the mold, it is immersed in a bath of a crosslinking agent such as glyoxal, a sugar aldehyde, glutaraldehyde, genipin, or a dicarboxylic acid (e.g., succinic acid, malonic acid, or others) at a concentration of 1-25%, more preferably 2-20%, most preferably 3%-10% v/v in a low-toxicity slightly polar solvent like ethanol, isopropanol, or acetone. The material is allowed to react for 1-48 hr, more preferably 6-24 hr, most preferably 4-12 hr to crosslink the film, increasing its strength and water resistance. The reaction may be accomplished at elevated temperatures such as 25-120° C., more preferably 30-90° C., and most preferably 50-85° C.

In another embodiment, the above reaction is performed with a monovalent amine-reactive molecule like an alpha-beta unsaturated carbonyl compound or an amine-reactive monoaldehyde or ketone such as benzaldehyde, cinnamaldehyde, or acetaldehyde to cap free amine groups and increase material water resistance. In this embodiment when using a Michael-active compound such as an alpha-beta unsaturated carbonyl compound, control of Michael vs. Schiff base reaction may be accomplished by controlling pH, where treatment at a range of 7-14 pH favors Michael-type addition, while treatment in acid conditions of 0-7 pH favors Schiff base formation. In this embodiment, reduction of the imine resulting from Schiff base-type addition of the amine may be favorable, and may be accomplished by reductive amination approaches such as by traditional reagents like sodium borohydride, sodium cyanoborohydride, or by hydrogenation or transfer hydrogenation of the imine.

In another embodiment, the demolded material is coated with a thin layer of a drying oil such as linseed oil. Excess oil is wiped away, and the drying oil allowed to polymerize in ambient conditions for 1-30 days, more preferably 3-10 days, most preferably 4-5 days, forming a water-resistant coating on the surface of the material.

In another embodiment of the invention, after the material is removed from the mold and before or after it undergoes subsequent processing as described in the previous embodiments, it is soaked in a plasticizer such as glycerol or sorbitol or plasticizer and solvent mixture to reintroduce plasticizer into the material. The concentration of plasticizer to solvent may range from 10-400% wt/wt solvent:plasticizer, more preferably 25-300%, most preferably 50-250%, or may be neat or molten plasticizer.

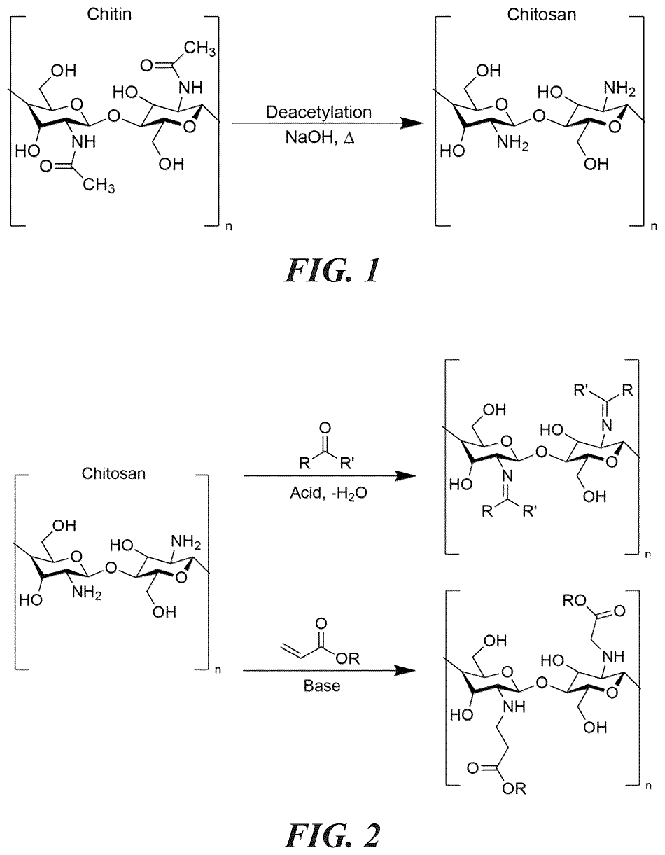

The leather material of the invention remediates the environmental challenges associated with toxic chemicals used in faux leathers and the animal leather tanning process. The material is made from chitin-derived chitosan. Chitin is the second most common biopolymer on earth (next to cellulose), derived from sources like insects exoskeletons, seashells, and fungal cell walls. Despite its abundance, chitin has not received the attention of other natural polymers, such as cellulose, possibly as it appears in nature in non-fibrous forms, unlike the cellulose present in cotton or linen. In fact, chitin is typically considered a waste material and is often simply discarded when produced as a byproduct of industrial processes like shrimp farming. Chemically, however, chitin can be used to produce a versatile class of biomaterials with tunable material properties accessible through simple “green” chemistry processes. The treatment of chitin as a waste residue despite its potential for biomaterial utilization presents a remarkable opportunity for developing the next generation of inexpensive, high-performance, and eco-friendly biobased materials. At the molecular level chitin is composed of long polymers of N-acetylglucosamine (see FIG. 1), a compound similar to the glucose that makes up the cellulose polymer of cotton. However, chitin differs from glucose in that its building blocks contain reactive amine and acetyl groups. These groups allow the polymers to be modified, changing their material properties and therefore the properties of materials made from them.

For instance, chitin is normally insoluble in water, but after treatment with base, many of the acetyl groups are removed, leaving a compound called chitosan, which contains free amine groups that greatly increase the polymers' solubility in water. This process also changes the length of the polymer chain, further modulating the polymer's bulk properties and solubility. The free amine groups are also themselves reactive and can be readily modified using simple and accessible chemistry (e.g., Michael addition or Schiff base formation) to add a wide variety of molecular modifications and crosslinks to control the material's strength, elasticity, toughness, and water resistance (see FIG. 2).

The resulting dissolved chitosan can be further mixed with natural fibers (preferably plant-based cellulose), natural plasticizers, or other biopolymers to form novel composite materials with strength and handfeel like that of natural leathers. These additives can change the bulk strength, tear resistance, and handfeel of the material. And, as the material is composed in the bulk of chitosan polymer, it remains biodegradable. As liquids, gels, or pastes, these solutions can be cast into molds or sheets with variable dimensions, thicknesses, and surface textures to mimic a variety of leather types.

Similarly, the material of the invention can be colored using both dyes and pigments to nearly any desired color. The material may be made more water resistant by neutralization of free acid and chitosan acid salt present in the material formed as the material is dehydrated by base. The salts formed by neutralization of the original solubilizing acids may be washed out, or simply left in the material, depending on the desired final mechanical properties. Treatments with amine-reactive molecules like carboxylic acids, ketones, aldehydes, and Michael-addition-reactive or Schiff base forming molecules can afford further modulation of the material's properties. Such treatments may be used to modulate the bulk material properties of the inventive material or to cap hygroscopic and solubilizing amine groups to reduce water solubility and increase water resistance. These treatments can be applied either at solubilization time or after molding, using a post treatment bath.

The chemical and process flexibility afforded by the use of chitin-derived biopolymers allows the invention to mimic, engineer, and even improve upon the capabilities and properties of a wide range of natural leathers, while simultaneously improving the overall sustainability and environmental friendliness of the production process and final material compared to natural or synthetic leathers.

More specifically, to form the bulk of the inventive material, chitosan is solubilized with an organic acid, preferably of low MW such as lactic acid, in water; then the chitosan solution is cast into a mold and the water and low MW organic acid are allowed to evaporate to form the final film. The degree of deacetylation (DD) and molecular weight (MW) of the chitosan is flexible, but does change both the processing required and final properties of the material. High MW and low DD chitosan takes longer to solubilize and may require heating to fully go into solution, but results in a stiffer, stronger sheet. In contrast, low MW and high DD chitosan is quickly solubilized at high pH, but produces less strong sheets.

The choice of organic acid has a dramatic effect on the performance of the material. Many acids, when used to solubilize low MW chitosan, result in high shrinkage and aggressive wrinkling of the film surface at higher drying rates. Citric and lactic acid, in contrast, produce well-behaved flat films, presumably due to water incorporation due to hydrophilicity on the part of citric acid, and spontaneous oligomerization for lactic acid. Very low or unstable organic acids like formic acid may be used advantageously to strip the majority of the remaining bound acid after drying by further heating, both driving off and decomposing acids with lower boiling points, resulting in water resistance of the final material. Similarly, functional grafting of carboxylic acids moieties in, e.g., lactic acid, adipic acid, or other polycarboxylic acids to free amine groups modulates the behavior of the material, capping and/or crosslinking them. In materials with protein content, crosslinking by, e.g., citric acid also contributes to water resistance. The relative concentration of acid to chitosan also strongly modulates the behavior of the material, with high acid concentrations resulting in more flexible materials, due to bifunctionality as plasticizers, and high chitosan, low acid mixtures resulting in stiff, brittle plastic-like films. The addition of acid to the chitosan in water and the dissolution of the chitosan dramatically increases the viscosity of the solution. If mixed vigorously, bubbles may be introduced into the solution which disrupt any molded textures to be formed during casting. However, bubbles may be deliberately introduced to form foamed materials, decreasing final film density, adding insulating properties, and changing final handfeel.

To further modulate the flexibility of the final sheets, common hydrophilic plasticizing molecules like sorbitol, glycerol, and polyethylene glycol can be added to the solubilized chitosan. At high concentrations, however, these molecules result in a hydroscopic film that is sensitive to relative humidity and sticky to the touch without further treatment. The addition of protein or peptide content such as silk peptide (fibroin, mostly containing alanine and glycine) may also act as a plasticizer, in addition to the water resistance properties imparted with certain organic acids, as described above. Depending on solubility and mobility, this plasticizer may be washed out in subsequent processing steps (though its inclusion when forming the original film may still be advantageous for processing reasons). This may be addressed by performing post-drying processing steps in isotonic or higher concentrations of plasticizer, or by using plasticizer itself as a solvent, or by a final step of replasticizing the material by a soak in a high- or neat-concentration plasticizer bath.

High-aspect ratio cellulosic materials like cellulose nanofibrils and microfibrils, also known as microfibrillated cellulose (MFC), can also be added to the chitosan solution to improve the mechanical properties (e.g., strength, stiffness and tear resistance) of the final film. MFC consists of cellulose liberated from lignocellulosic feedstocks by digestion and high shear treatments, resulting in free, very long, very low diameter fibrils in their plant native state. These fibrils are very strong (because of their high molecular orientation and high crystallinity) and can be added to the chitosan film to dramatically improve its tensile strength and tear resistance in a manner proportional to fibril concentration. In aerated chitosan materials (as described above), the fibrils also stabilize bubbles in the material, allowing more effective foam formation. The fibrillar nature of these materials is critical to their action in the final film. However, microcrystalline cellulose (MCC) or other particulate matter does not exhibit the same improvements in strength and tear performance. The addition of MFC to the chitosan solution requires care, as MFC is difficult to fully disperse. Dispersion requires either very long mixing times or high-shear mixing, so MFC addition and dispersion should take place before the addition of acid and chitosan solubilization to keep the mixing viscosity suitably low and reduce addition of bubbles, if not forming a foamed material.

Larger-scale fillers like cellulose or cotton or short fiber, such as paper pulp, can also be added to modulate the surface properties of the final film. These fibers also contribute to the mechanical properties of the final material, rendering them stiffer and stronger. When films containing high concentrations of short fibers are abraded, either deliberately or during their typical use, these short fibers are exposed on the surface of the material, giving the material a soft, suede-like feel. This treatment may also be applied to only a layer of the final material, with a core, more flexible cast layer remaining without pulp or fiber.

Dyes, pigments, and/or other colorants can also be added to the chitosan solution to change the color of the inventive final material and give it a designer look. As they remain bound in the chitosan matrix, they need not be chemically active small molecules. Traditional non-toxic mineral pigments like ochre or carbon black are suitable. In addition, optically active materials like glass powder or mica may be added to produce a variety of non-natural colors, hues, and shines, ranging from matte to metallic.

Crosslinking agents like genipin (CAS Number: 6902. 77-8), glyoxal (OCHCHO), any of the sugar aldehydes, and glutaraldehyde (OCH(CH₂)₃CHO) may also be added once the chitosan is solubilized. These compounds react with free amine groups in the chitosan chains, crosslinking chains together and to themselves and profoundly change the final material's properties, resulting in gel-like behavior and water resistance. During preparation, the addition of crosslinkers can result in a dramatic increase in viscosity, up to the point of gelling, so care must be taken in concentration and reaction time to ensure the solution may still be successfully cast into molds to form the final films.

Following component mixing and chitosan solubilization, the mixture can be poured into mold to evaporate away water solvent and low MW acid. The depth of the pre-evaporation layer controls the final thickness of the material, for a given chitosan concentration. The rate of drying and relative humidity have an impact on the final material; very long, hot drying (e.g., 24 hr, 90° C.) drives off water and acid required for material flexibility, resulting in brittle films. Similarly, the rate of water removal modulates shrinkage: fast drying results in shrinkage defects like wrinkling as the material does not have time to come to equilibrium between the exposed drying surface of the mixture in the mold and the bulk. If poured into a mold with a texture or pattern embossed into its surface, the final film to be patterned accordingly, allowing for the generation of desired patterns, mimicking snakeskin, etc., in the final material, such as those resembling exotic leathers or geometric shapes.

Typical industrial film-forming or coating operations may also be used to form the material. In these cases, the solids content of the dope should be as high as possible to accelerate drying in a tunnel dryer, though the gelling thresholds of chitosan solutions means dryer residence times may be longer than typical for other, high-solids-content waterborne coatings or particularly solvent-borne coatings using high volatility solvents or carriers. The solids content limitations also mean wet films are very thick compared to many typical coating operations, extending to many millimeters. Coating heads should therefore be selected to be able to produce such thick films, with knife coating or slot-die coating being the clearest choices. Minimizing the thickness of the final coating may also help address this problem, so use of backing fabrics that allow for thinner final dry coatings can be advantageous. Coating onto release papers may be used to produce free-standing films, though they may be thicker for reasons of strength without backings. Multiple coating operations may be used on just- or pre-formed films to form laminates or layered materials by varying the recipe per layer, optimizing e.g. the “back” layer for strength, and the “top” layer for handfeel and/or water resistance. Similarly, dope or water may be used to form adhesive-less laminates by re-solubilizing the interface between pre formed sheets, which can then “solvent weld” together to form a monolithic new sheet using typical adhesive coating equipment. Dope may also be used as an adhesive to backing fabrics, but must be carefully metered, and/or applied to heavily sized fabric to prevent dope from soaking into the substrate and binding the fabric yarns and fibers together, forming a stiff composite, rather than a pliable fabric.

In certain cases, it might be advantageous to use adhesives to attach a backing layer. In these cases, all natural glues like natural latex suspensions or mastic-based adhesives may be coated on to the material and laminated with a backing fabric. Adhesion of the fabric and biomaterial with these unconventional adhesives may benefit from aggressive surface roughening and surface washing to remove residual plasticizer from the top layer of the material prior to adhesive application.

Following drying to low moisture content (typically <10%), the material can be stripped from the mold or release liner. However, without further treatments, most recipes result in films that are still hygroscopic and water soluble, so further treatment may be required to render them more usable as leather substitute materials. In general, these treatments should either 1) form a protective barrier on the outside of the material to prevent moisture ingress and/or 2) chemically modify the underlying material to cap or crosslink the free amine groups responsible for chitosan's solubility at low pH.

One variant of these approaches is to use natural lipid/polymers like drying oils (e.g., linseed oil) or natural waxes (e.g., beeswax), to form a water-resistant barrier. This may be accomplished by simply coating on a drying oil, like linseed oil, and allowing the oil to oxidize and polymerize, forming an impermeable durable layer, or brushing on a layer of wax.

Chemical modification requires more controlled reaction conditions to accomplish reactions with the chitosan's free amines In the absence of water, for instance, carboxylic acids can react with amines with sufficient energy input to from an amide bond. This reaction is unfavorable, so an excess of the carboxylic acid may be used to drive the reaction. To accomplish this, a hydrophobic long chain fatty carboxylic acid like stearic acid or lauric acid may be melted into a bath, and the dried film placed into it for treatment. Treatment length and temperature depends on desired degree of water resistance and film thickness, but long, hot treatments may decompose or drive off plasticizing compounds in the film, or over infiltrate brittle fatty acid into the material, resulting in brittleness. After treatment, the film can be removed from the molten carboxylic acid, and excess acid washed off in a suitable non-polar solvent like mineral or vegetable oil.

Similarly, the solubilizing amines may be reacted with crosslinking agents like glyoxal, genipin, any of the sugar aldehydes, or glutaraldehyde to render the material no-longer water-soluble. This can be accomplished using a gentle non-aqueous solvent system like ethanol or acetone, into which the crosslinker is dissolved for treatment. Non-crosslinking compounds like single-aldehyde compounds may also be used to cap, rather than crosslink, free amines.

Other non-crosslinking amine-reactive compounds like alpha-beta unsaturated ketones may also be employed to cap free amines in a Schiff-base or Michael-type reaction, such as an overnight wash with 10% cinnamaldehyde in ethanol. In this case the wash solution should not be acetone, as acetone will undergo Michael additions itself, and should be neutral to basic in pH. Notably, when undergoing Schiff-base reactions, the resulting compound is an imine, rather than an amide. In some cases, this bond may be stable enough for productive use; however, hydrolysis may be further prevented as necessary by conversion of the imine to the more stable amide by a number of reduction and trans-reaction techniques.

The above chemical treatments represent prototypical treatments, in general. However, any compound amine-reactive enough to react with the material may be used for waterproofing, or to otherwise modify the chemistry, and correspondingly material properties, of the bulk material. Such additions may be accomplished with a huge variety of molecules, many of which in the case of aldehydes occur naturally and are used as flavor or fragrance compounds, affording a high degree of material “programmability” by this technique. Post-treatment washing is required to remove unreacted free crosslinker or other reaction molecules. Treatments may also be mixed and matched to tune the final desired performance and behavior, e.g., a capping reaction with aldehyde may be followed by a drying oil treatment, followed by a wax coating to ensure robust protection.

The invention is further defined by reference to the following examples, which are intended to be illustrative, not limiting.

### Example 1

### Basic Recipe

Chitosan (>95% DD, ˜150 KDa MW), microfibrillated cellulose/cellulose nanofibrils (MFC), and pigment powder were added to water to a final concentration of 3.33%, 0.183%, and 0.1% respectively, and mixed for minimum 5 min under high shear using an Instant Pot Ace Nova blender on its highest speed (˜25,000 rpm) until completely homogenized at 50° C. Sorbitol was added to a concentration of 1.5% as a plasticizer and mixed at low shear with a paddle mixer at ˜1500 rpm to fully integrate the miscible components to homogeneity while avoiding adding air bubbles and excess energy usage. The chitosan in the mixture was solubilized by adding 5.87% lactic acid and mixed to homogeneity for 1 min. The solution was poured into molds to a depth of 1 cm through a strainer to remove large bubbles and any unhomogenized components. Once molded, a flame was passed over the liquid to remove surface bubbles. This process was repeated once more with a 10 min interval between treatments. Alternatively, vacuum degassing could be used to remove bubbles. Following bubble removal, the solution was allowed to evaporate to form a sheet. Drying was accomplished at 50° C. and 1 m/s air flow over the surface of the mold. Additional samples were prepared identically but with identical molar concentrations of a different plasticizer including glycerol, sorbitol, isomalt, inositol, sucrose, 1,3-propanediol, dimethylisosorbide, PEG400, and ethoxydiglycol.

In Examples 3-9, the process of Example 1 was followed unless otherwise stated.

### Example 2

### Continuous Processing Using Web Coating

Liquid dope as formed in Example 1 may be coated onto substrates using suitable thick-film forming methods like doctor blade or knife coating, comma coating, or slot-die coating. This coating may be accomplished in a roll-to-roll continuous manner by utilization of a tunnel dryer following the coating operation. Coated substrates may include woven or non-woven webs producing backed fabric similar to synthetic leathers or may be release papers which are removed in a stripping step to form free-standing backing-less films. Release liners may be patterned to impart texture to the final film as in solvent-born synthetic leather manufacturing processes. Multiple layers of dope may be applied with partial or full drying between coating steps to create complex layered forms, and dry films may be similarly laminated by re-wetting non-waterproofed films and/or by the addition of further dope as an “adhesive”.

### Example 3

### Use of PEG8K Plasticizer

Chitosan, MFC, and pigment powder were added to water to a final concentration of 3.33%, 0.183%, and 0.1% respectively, and mixed until completely homogenized at 50° C. Polyethylene Glycol 8000 (PEG8k) was added to a final concentration of 1%, and mixed until dissolution. Chitosan was solubilized with 5.87% lactic acid and mixed to homogeneity. The solution was poured into molds and evaporated to form a sheet.

### Example 4

### Use of Pre-Oligomerized Lactic Acid

Chitosan, MFC, and pigment powder were added to water to a final concentration of 3.33%, 0.183%, and 0.1% respectively, and mixed until completely homogenized at 50° C. Sorbitol was added to a final concentration of 1.5%. Lactic acid was oligomerized by removal of water with molecular sieves followed by 1 week aging at room temperature (RT), then added to a final concentration of 5.87% and mixed to homogeneity. The solution was poured into molds and evaporated to form a sheet.

### Example 5

### Use of Higher Ratios of Chitosan to Acid to Produce a Brittle Plastic

Chitosan, MFC, and pigment powder were added to water to a final concentration of 6.67%, 0.183%, and 0.1% respectively, and mixed until completely homogenized at 50° C. Lactic acid was added to a final concentration of 2.67%, and the solution mixed at 50° C. for 15 min to solubilize the chitosan. The mixture was cast into molds to a depth of 1 cm, and dried to produce a stiff, brittle sheet.

### Example 6

### Use of Glutaraldehyde as a Crosslinker

Chitosan, MFC, and pigment powder were added to water to a final concentration of 3.33%, 0.183%, and 0.1% respectively, and mixed until completely homogenized at 50° C. Sorbitol was added to a final concentration of 1.5%. Chitosan was solubilized with 5.87% lactic acid and mixed to homogeneity. Glutaraldehyde was added as a crosslinker to a final concentration of 1.25%. The solution was mixed to homogeneity and immediately cast to a depth of 1 cm and allowed to evaporate. The resultant film was inherently water resistant.

### Example 7

### Use of Glyoxal Crosslinker

Chitosan, MFC, and pigment powder were added to water to a final concentration of 3.33%, 0.183%, and 0.1% respectively, and mixed until completely homogenized at 50° C. Sorbitol was added to a final concentration of 1.5%. Chitosan was solubilized with 5.87% lactic acid and mixed to homogeneity. Glyoxal was added as a crosslinker to a final concentration of 4%. The solution was mixed at 50° C. for 15 min and cast to a depth of 1 cm and allowed to evaporate. The resultant sheet was inherently water resistant.

### Example 8

### Use of Citric-Acid to Crosslink Added Protein

Chitosan, MFC, pigment powder and silk peptide were added to water to a final concentration of 3.33%, 0.183%, 0.1%, 1.82% respectively, and mixed until completely homogenized at 50° C. Sorbitol was added to a final concentration of 1.5%. Chitosan was solubilized with 3% citric acid and mixed to homogeneity, which acted as a gentle crosslinker for the silk peptide. The solution was mixed at 50° C. for 15 min and cast to a depth of 1 cm and allowed to evaporate. The resultant sheet was inherently water resistant.

### Example 9

### Use of Formic Acid

Chitosan, MFC, and pigment powder to water to a final concentration of 3.33%, 0.183%, and 0.1%, respectively, and mixed until completely homogenized at 50° C. Sorbitol was added to a final concentration of 7.5%. Chitosan was solubilized with 2.67% formic acid and mixed to homogeneity. The solution was mixed at 50° C. for 15 min and cast to a depth of 1 cm and allowed to evaporate. Following casting, the material was heated above the decomposition point of formic acid to −90° C. for −1 hr to destroy free formic acid and disrupt chitosan-formate salts, rendering the material stiff and inherently water resistant.

### Example 10

### Surface Modification

Chitosan, MFC, pigment powder, and a short cellulosic fiber or pulp as an additive were added to water to a final concentration of 3.33%, 0.183%, and 0.1% respectively, and mixed until completely homogenized at 50° C. Sorbitol was added to a final concentration of 1.5%. Chitosan was solubilized with 5.87% lactic acid and mixed to homogeneity. The solution was poured into molds and evaporated to form a sheet. Post molding, material surface was roughened using an abrasive to expose and liberate fibers, adding softness to the material's surface texture.

### Example 11

### Use of Aeration

Chitosan, MFC, and pigment powder were added to water to a final concentration of 3.33%, 0.366%, and 0.1% respectively, and mixed until completely homogenized at 50° C. Sorbitol was added to a final concentration of 1.5%, and mixed until dissolution. Chitosan was solubilized with 5.87% lactic acid and mixed to homogeneity. Sodium dodecyl sulfate (SDS) was added as a surfactant to a final concentration of 0.05%. The solution was mixed at high speed to form a foam, which was poured into molds and dried with air movement (1 m/s) and heat (50° C.) without straining or degassing. The resulting material contained significant air pockets in the final sheet, reducing density, adding insulating capabilities, and changing the handfeel of the material.

### Example 12

### Higher Solids Content Dopes

To accelerate the drying process, the water content of the material was reduced to ¼ of its typical value, producing a pourable, but high-viscosity dope. The increased viscosity also assists in forming thicker wet films during coating rather than molding operations, in addition to accelerating drying time.

### Example 13

### Recipe Lacking Plasticizer

Since in some techniques further steps would wash out excess plasticizer, resulting in waste, the recipe from Example 1 was used to form sheets as normal with omission of the sorbitol plasticizer.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

In Examples 14-23 the starting material was material produced according to example 1, though examples 2-12 may also be used with any of the following techniques, unless otherwise noted.

### Example 14

### Waterproofing Methods Using a Molten Long-Chain Fatty Acid Wash

### Variant 1, Molten Long-Chain Fatty Acid Wash, Lauric Acid

Dried material was soaked in lauric acid 80° C. for an average of 1 hr. The material was removed from the carboxylic acid treatment while still hot, and wiped clean. Once cooled, excess carboxylic acid was washed by using a 5 min soak and scrub in vegetable oil at room temperature, rendering the final sheet resistant to water.

### Variant 2, Molten Long-Chain Fatty Acid Wash, Stearic Acid

Dried material derived from the first of the above recipes was soaked in stearic acid at 80° C. for 1 hr. The material was removed from the carboxylic acid treatment while still hot, and wiped clean. Once cooled, excess carboxylic acid was washed by using a 5 min soak and scrub in vegetable at room temperature

These techniques render the final sheet resistant to water.

### Example 15

### Waterproofing Method Using Neutralization of Residual Acid and Regeneration of Free, Unsalted Chitosan Amines

### Variant 1

Dried material was soaked overnight in a 5M base bath of sodium hydroxide in water with gentle mixing. The sample was removed from the base bath, and placed in a second water bath with gentle mixing for 3 hr to remove residual unreacted base and newly formed salts. This process was repeated three more times until the final bath was pH neutral.

### Variant 2

Dried material derived from one of the above recipes was soaked overnight in a 5M base bath of sodium hydroxide in water with gentle mixing. The sample was removed from the base bath, and placed in a second water bath with gentle mixing. Acid such as citric or lactic acid was added by hand or by automated dosing pump until the bath remained within pH range 6.5-7.5 for 3 hrs. The sample was then moved to a fresh water bath and washed overnight with gentle mixing to remove residual salts.

These techniques neutralize the chitosan acid salt, rendering the material water resistant as well as changing the surface energy of the material, improving handfeel.

### Example 16

### Waterproofing Method Using a Drying Oil

Dried material was liberally coated with linseed oil. Excess material was wiped away, and the oil coating allowed to polymerize for 1 week at RT in ambient conditions. This technique leaves a thin water-resistant coating on the material surface while preserving the flexibility of otherwise untreated films.

### Example 17

### Waterproofing Method Using an Aldehyde Crosslinking Bath

Dried material derived from several of the above recipes was soaked overnight at RT in a 10% bath of the short aldehyde glyoxal in a slightly polar non-aqueous solvent of ethanol. Glyoxal in ethanol is preferred, given its low toxicity. The material was then washed again in clean solvent to remove unreacted compounds. Otherwise identical examples were also formulated with glutaraldehyde instead of glyoxal, and/or isopropanol instead of ethanol. This technique crosslinks the polymer, adding water resistance and resistance to swelling.

### Example 18

### Waterproofing Method Using a Non-Dialdehyde Crosslinking Bath

### Variant 1

Dried material was soaked overnight at RT in a 10% bath of the Michael-addition active alpha-beta unsaturated carbonyl compound cinnamaldehyde, in a slightly the polar non-aqueous solvent ethanol. The solution should be neutral to basic, so a pre-wash in a non-aqueous solvent to remove excess organic acid or full neutralization was necessary for highest efficiency. The material is then washed overnight in clean solvent to remove unreacted compounds. Otherwise, identical examples were also performed using isopropanol, and/or with other a-b-unsaturated aldehydes including citral, and trans-2-octanal

### Variant 2

Material in an identical bath as described above was heated under gentle reflux at or near the solvent's boiling point for 3 hrs to increase the reaction rate and drive efficiency, and then washed as before. Otherwise identical examples were also performed using isopropanol, and/or with other a-b-unsaturated aldehydes including benzaldehyde, citral, trans-2-octanal, 2-napthaldehyde, 3,4,5-trimethoxybenzaldehyde, and 3,4-dihydroxybenzaldehyde.

These techniques stiffen the material and add water resistance. Treatment times, aldehyde concentrations, and choice of aldehyde were used to modulate efficiency/yields and thus affected the mechanical properties of the final films.

### Example 19

### Waterproofing Method Using Schiff-Base Forming Capping Bath

Dried material was heated under gentle reflux at or near the solvent's boiling point baths of the non-alpha-beta unsaturated monoaldehyde hexanal at 10% in ethanol. The samples were refluxed for 3 hrs. Samples were then washed overnight in similar solvents to remove unreacted aldehydes. In this case, residual acid from non-neutralized samples helps favor Schiff base formation. Following the reaction, the formed imine was reacted to the amine by the addition of sodium borohydride. Otherwise identical reactions were performed with isopropanol and/or with other aldehydes including octanal, nonanal, decanal, citronellal, hydroxycitronellal, 3-phenylpropionaldehyde, and propionaldehyde.

### Example 20

### Replasticization after Neutralization and/or Aldehyde Treatment

### Variant 1

Dried, treated material from Examples 15, 17, 18, or 19, were soaked overnight at RT in a 2:1 wt/wt ratio of glycerol plasticizer to water in order to re-plasticize the material.

### Variant 2

Dried, treated material from Examples 15, 17, 18, or 19, were soaked overnight at RT in saturated sorbitol plasticizer solutions in order to re-plasticize the material.

### Variant 3

Dried, treated material of Examples 15, 17, 18, or 19, were soaked overnight at RT in saturated isomalt plasticizer solutions in order to re-plasticize the material.

### Example 22

### Waterproofing Treatment Baths Including Plasticizers

### Variant 1

Dried material including plasticizer, (i.e., not material produced as described in Example 13) was treated as described in Examples 15, 17, 18, or 19 but with the addition of plasticizers to the treatment baths. The concentration of the plasticizer in the bath was matched to the concentration of the plasticizer in the starting material. That is, the plasticizer concentration was isotonic with the material in order to prevent plasticizer washout by leaching or osmotic forces during treatment baths. Plasticizers used in this manner included glycerol, sorbitol, isomalt, urea, inositol, glycine, sucrose, 1,3-propanediol, dimethylisosorbide, PEG400, and ethoxydiglycol.

### Variant 2

Dried material including plasticizer, (i.e., not material produced as described in Example 13) was treated as described in Examples 15, 17, 18, or 19 but with the addition of plasticizers to the treatment baths. Plasticization baths were saturated in the case of solid plasticizers or at a 2:1 wt/wt ratio with water in the case of liquid plasticizer. Plasticizers used in this manner included glycerol, sorbitol, isomalt, urea, inositol, glycine, sucrose, 1,3-propanediol, dimethylisosorbide, PEG400, and ethoxydiglycol.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A flexible leather-like material comprising:
1) 10-90 wt/wt % chitosan, wherein the chitosan is of 10-530 KDa MW, having a DD of 50-99%,
2) 0-50 wt/wt % microfibrillated cellulose/cellulose nanofiber (MFC/CNF),
3) 0-25 wt/wt % organic plasticizer, and
4) residual water content of 0-30% wt/wt %.

2. A material of claim 1 comprising:
1) 15-85 wt/wt % chitosan, wherein the chitosan is of 25-530 KDa MW, having a DD of 75-99%, and
2) 5-30 wt/wt % microfibrillated cellulose/cellulose nanofiber (MFC/CNF).

3. A material of claim 1 comprising:
1) 20-80 wt/wt % chitosan, wherein the chitosan is of 50-200 KDa MW, having a DD of >80%.

4. A material of claim 1 further comprising less than 50 wt/wt % organic acid, preferably organic acid selected from the group consisting of lactic acid, citric acid, and formic acid and a combination thereof.

5. A material of claim 1 further comprising 0.01-40% v/w % of the product of a crosslinking agent and chitosan.

6. A material of claim 5 wherein the crosslinking agent is selected from the group consisting of glutaraldehyde, glyoxal, sugar aldehyde, and genipin, or other small molecule dialdehydes.

7. A material of claim 5 wherein the concentration is 5-30 v/w %.

8. A material of claim 5 wherein the concentration is 10-20 v/w %.

9. A material of claim 1 further comprising the product of a reaction with 0.01-20% v/w % of a Michael-active or Aldol-active compound which is an alpha-beta unsaturated carbonyl compound, an aldehyde or a ketone with concentration 1-20% v/w %, more preferably, 5-10% v/w %.

10. A material of claim 9 wherein the aldehyde is cinnamaldehyde and the concentration is 5-10% v/w %.

11. A material of claim 1 further comprising 0-20%, wt/wt % more preferably 0.005-10%, and most preferably 0.01-5% of reducing sugars.

12. A material of claim 1 wherein the solids concentration is increased for the purposes of increasing suitability for continuous drying processes, the solids content being preferably to 4-20 wt/wt %, more preferably 5-18 wt/wt %, or most preferably 6-15 wt/wt %.

13. A material of claim 1 further comprising a backing woven or non-woven fabric applied to one surface of the material using a natural adhesive such as a natural rubber latex or the liquid form of the material as an adhesive.

14. A process for producing the material of claim 1 which comprises:
1) mixing the chitosan and MFC/CNF to homogeneity in water under high shear along with dye or pigment coloring agents in a final water mass of liquid of 10×-50× the mass of the chitosan;
2) after homogenization, adding the remaining ingredients and mixing to homogeneity under lower shear;
3) then casting the mixture into a mold with or without a pattern; and
4) evaporating the water under gentle heating with gentle airflow over the mold surface.

15. The process of claim 14, wherein the remaining ingredients added further comprise 10-60 wt/wt % organic acid, and wherein the amount of organic acid is later reduced in the resulting material.

16. A process of producing the material of claim 1 which comprises a web-coating operation applying the material to a substrate such as a woven or non-woven backing fabric or a textured or untextured release liner followed by continuous drying to form films in a roll-to-roll manner.

17. A process for waterproofing the flexible leather-like material of claim 1 which comprises:
1) coating the material with a drying oil;
2) wiping away excess oil; and
3) allowing the drying oil to polymerize under ambient conditions for 1-30 days.

18. A process which comprises immersing the flexible leather-like material of claim 1 in a bath of a crosslinking agent which is glyoxal, sugar aldehyde, glutaraldehyde, genipin, or a dicarboxylic acid at a concentration of 1-25% v/v in a low-toxicity slightly polar solvent which is ethanol, isopropanol, or acetone; and allowing the reagents to react with the immersed product.

19. A process which comprises immersing the flexible leather-like material of claim 1 in a base bath of 0.1-19.4M, followed by at least one of:
a series of water baths to remove formed salt and residual base,
immersion in a second bath and neutralization of residual base by controlled addition of acid, followed by a water bath to remove formed salt, or
immersion in a second bath and neutralization of residual base by controlled addition of acid.

20. A process for capping chitosan free amines in the flexible leather-like material of claim 1 which comprises immersing the material for 0.01-48 hr in a room temperature or heated bath or reflux reaction of an aldehyde.

21. A process of claim 19 undertaken under conditions designed to prevent washout of plasticizer by addition of isotonic or higher plasticizer concentrations in the reaction baths by inclusion of liquid plasticizer in treatment baths.

22. A process of claim 19 further comprising a plasticizer wash-back step whereby treated material is immersed in a high-concentration plasticizer bath of 50% wt/wt to neat or molten plasticizer to reintroduce plasticizer to the treated material.

23. A process for forming a flexible leather-like material comprising:
1) mixing 10-90 wt/wt % chitosan, wherein the chitosan is of 10-530 KDa MW, having a DD of 50-99% and 0-50 wt/wt % microfibrillated cellulose/cellulose nanofiber (MFC/CNF) to homogeneity in water under high shear along with dye or pigment coloring agents in a final water mass of liquid of 10×-50× the mass of the chitosan;
2) after homogenization, adding 10-60 wt/wt % organic acid, 0-25 wt/wt % organic plasticizer and mixing to homogeneity under lower shear than the earlier mixing;
3) casting the mixture into a mold with or without a pattern; and
4) evaporating the water under gentle heating with gentle airflow over the mold surface.

24. The process of claim 23, wherein the gentle heating is at a temperature of 25-90° C. and wherein the gentle airflow over the mold surface is at a rate of >0-5 m/s.

25. The process of claim 23 wherein the mold is a surface of a roll in a roll-to-roll process.
